(19) United States
(12) Patent Application Publication
(10) Pub. No.: US 2019/0087640 A1
(43) Pub. Date: Mar. 21, 2019

(54) IMAGE CAPTURING DEVICE, IMAGE CAPTURING METHOD AND STORAGE MEDIUM

(71) Applicant: CASIO COMPUTER CO., LTD, Tokyo (JP)

(72) Inventors: Junichi Miyasaka, Tokyo (JP); Yohei Araki, Tokyo (JP); Tsuyoshi Matsunaga, Sayama-shi (JP); Takao Nakai, Tokyo (JP)

(21) Appl. No.: 16/135,369

(22) Filed: Sep. 19, 2018

(30) Foreign Application Priority Data
Sep. 20, 2017 (JP) 2017-179768
Oct. 5, 2017 (JP) 2017-194829

(51) Int. Cl. G06K 9/00; G06T 7/70; G06T 7/11; H04N 5/235; H04N 5/225

(52) U.S. Cl. CPC G06K 9/00228; G06T 7/70; H04N 5/2256; H04N 5/2354; G06T 7/11

(57) ABSTRACT

An image capturing device, including: an image capturer; a plurality of light emitters which is arranged around the image capturer and emits light for illuminating a subject; and a controller, wherein the controller detects a face area of the subject from an image captured by the image capturer, determines a state of the detected face area, and controls a light emitting manner of the light emitter based on a determination result.

### CROSS-REFERENCE TO RELATED APPLICATIONS

This application is based upon and claims the benefit of priority from the prior Japanese Patent Application No. 2017-179768, filed on Sep. 20, 2017 and the Japanese Patent Application No. 2017-194829, filed on Oct. 5, 2017, the entire contents of which are incorporated herein by reference.

### BACKGROUND OF THE INVENTION

### 1. Field of the Invention

The present invention relates to an image capturing device, an image capturing method and a storage medium.

### 2. Description of Related Art

There has been conventionally suggested a camera which includes a ring strobe around the lens and causes the ring strobe to emit light at the time of photography, and thus can photograph a subject in a bright environment especially when close-up photography is performed at a dark place, as described in Japanese Patent Application Laid Open Publication No. 2006-084599.

### SUMMARY OF THE INVENTION

There is provided an image capturing device, including: an image capturer; a plurality of light emitters which is arranged around the image capturer and emits light for illuminating a subject; and a controller, wherein the controller detects a face area of the subject from an image captured by the image capturer, determines a state of the detected face area, and controls a light emitting manner of the light emitter based on a determination result.

There is also provided an image capturing method in an image capturing device that includes an image capturer and a plurality of light emitters which is arranged around the image capturer and emits light for illuminating a subject, the method including: a detection step of detecting a face area of the subject from an image captured by the image capturer; a determination step of determining a state of the face area detected in the detection step, and a control step of controlling a light emitting manner of the light emitter based on a determination result by the determination step.

There is also provided a non-transitory storage medium storing a program which is readable by a computer used in an image capturing device that includes an image capturer and a plurality of light emitters which is arranged around the image capturer and emits light for illuminating a subject, the program causing the computer to function as: a detector which detects a face area of the subject from an image captured by the image capturer; a determiner which determines a state of the face area detected by the detector, and a controller which controls a light emitting manner of the light emitter based on a determination result by the determiner.

### BRIEF DESCRIPTION OF THE DRAWINGS

The above and other objects, advantages and features of the present invention will become more fully understood from the detailed description given hereinafter and the appended drawings which are given by way of illustration only, and thus are not intended as a definition of the limits of the present invention, and wherein:

FIG. 1A is a front view of an image capturing device;

FIG. 1B is a right lateral view of the image capturing device;

FIG. 2 is a block diagram showing the functional configuration of the image capturing device;

FIG. 3 is a flowchart showing photographing control processing executed by a controller in FIG. 2; and

FIG. 4 is a view showing a rate of light emission amount of a light emitter.

### DETAILED DESCRIPTION OF THE PREFERRED EMBODIMENT

Hereinafter, an embodiment according to the present invention will be described in detail with reference to the accompanying drawings. The present invention is not limited to the illustrated examples.

### [Configuration of Image Capturing Device 1]

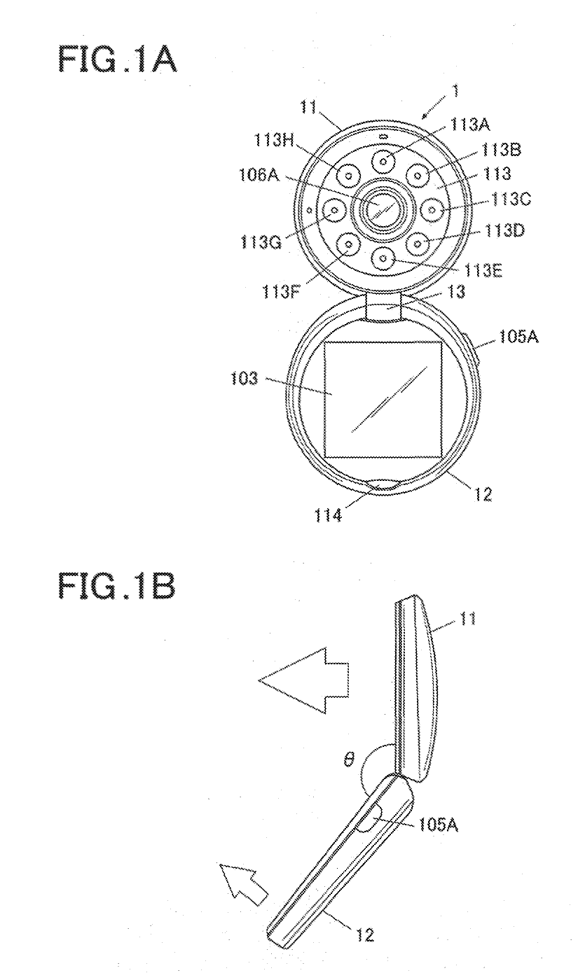

FIG. 1A is a front view of an image capturing device 1 according to the embodiment.

FIG. 1B is a right lateral view of the image capturing device 1. The image capturing device 1 is an image capturing device in a compact shape mainly for a user to capture his/her own face as a subject.

As shown in FIGS. 1A and 1B, the image capturing device 1 is configured by including an image capturing unit 11 included in a first case, a display unit 12 included in a second case and a hinge 13.

The image capturing unit 11 includes an image capturing lens 106A on a front side facing the subject, and a light emitter 113 which is arranged around the image capturing lens 106A and emits light for illuminating the subject.

In the embodiment, the light emitter 113 is configured by arranging eight LEDs (Light Emitting Diodes) 113A to 113H at equal intervals around the image capturing lens 106A. However, the present invention is not limited to this.

The display unit 12 includes a display 103 configured by including a square LCD (Liquid Crystal Display) and the like and a light emitter 114 on the front side facing the subject.

The display unit 12 is provided with a shutter key 105A for instructing photography.

The image capturing unit 11 and the display unit 12 are configured to be rotatable around a hinge 13, and can be folded (closed) such that the surface on the image capturing lens 106A side of the image capturing unit 11 and the surface on the display 103 side of the display unit 12 are located inward.

As shown in FIG. 1B, it is possible to irradiate the subject from two directions by the light emitter 113 and the light emitter 114 at the time of photography by making the angle θ between the image capturing unit 11 an the display unit 12 smaller than 180° at the time of photography.

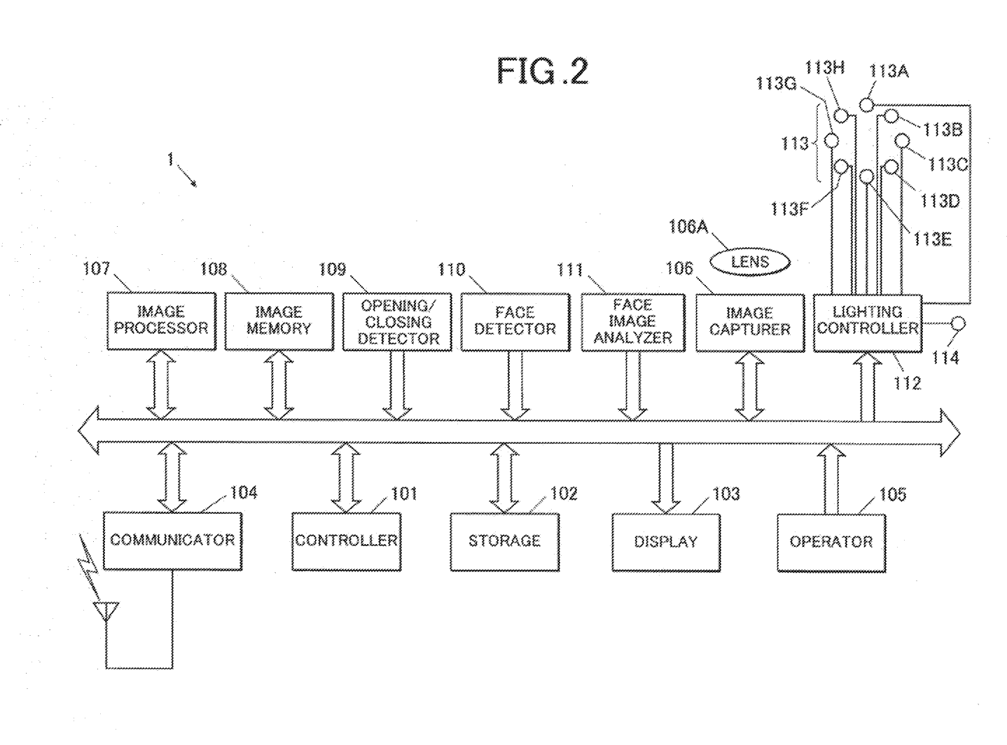

FIG. 2 is a block diagram showing the functional configuration of the image capturing device 1.

As shown in FIG. 2, the image capturing device 1 is configured by including a controller 101, a storage 102, a display 103, a communicator 104, an operator 105, an image capturer 106, an image processor 107, an image memory 108, an opening/closing detector 109, a face detector 110, a face image analyzer 111, a lighting controller 112, a light emitter 113, a light emitter 114 and the like.

The controller 101 and the components are connected via a bus.

The controller 101 is configured by including a CPU (Central Processing Unit), a RAM (Random Access Memory) and the like, and performs predetermined arithmetic processing and controls the components by executing the various programs stored in the storage 102.

The controller 101 functions as a determiner and a controller.

The storage 102 is configured by including a non-volatile semiconductor memory, a hard disk or the like.

The storage 102 stores system programs and various types of processing programs executed in the controller 101, data necessary to execute these programs and the like.

The display 103 is configured by including a square LCD or the like, and displays, for example, a live view image showing the state being captured by the image capturer 106 and displays an image of the subject or the like which was obtained by the image capturer 106 according to the photographing instruction, in accordance with the display control signal from the controller 101.

The communicator 104 is an interface for performing data communication with an external device in a wireless or a wired manner.

The operator 105 includes various types of function buttons such as the shutter key 105A, receives pressing input of each button by the user and outputs the operation information to the controller 101.

The image capturer 106 is configured by including an image capturing lens 106A, an image capturing element (not shown in the drawings) formed of an image sensor or the like such as a CCD (Charge Coupled Device) and a CMOS (Complementary Metal-oxide Semiconductor), an A/D conversion circuit and the like, and converts an optical image which passed through the image capturing lens 106a into a two-dimensional image signal by the image capturing element, and obtains the image data (RGB data).

After color processing including pixel interpolation processing and gamma correction processing performed to the RGB data obtained by the image capturer 106, the image processor 107 converts the data into image data (YUV data) formed of brightness signal Y and color difference signals Cb and Cr which are digital values.

The image processor 107 performs encoding of the YUV image data in a predetermined encoding method.

The image memory 108 is a recorder which is configured by including a flash memory, for example, and records image data which was captured by the image capturer 106 and processed by the image processor 107.

The opening/closing detector 109 detects whether the image capturing unit 11 and the display unit 12 are in a closed state (closed state, the state in which the angle θ is smaller than a predetermined angle) or in an open state (open state, the state in which the angle θ is the predetermined angle or more), and outputs the detection signal to the controller 101.

The face detector 110 detects a face area from the image captured by the image capturer 106 in accordance with instruction of the controller 101.

The face area can be detected by using a known image processing technique such as pattern recognition.

The face image analyzer 111 determines the state of the subject (for example, the direction of face (rotation degree)) on the basis of the position of the face area detected by the face detector 110, the sizes of left and right eyes and the like, in accordance with the instruction of controller 101.

The face detector 110 and the face image analyzer 111 may be achieved by cooperation between the controller 101 and the program stored in the storage 102, or may be achieved by a dedicated hardware.

The lighting controller 112 (driver) is connected to each of the LEDs 113A to 113H and LED of the light emitter 114, and controls the light amount and on/off of the light for each of them, in accordance with the instruction from the controller 101.

The light emitter 113 is configured by including a plurality of light emitting members (LEDs 113A to 113H) arranged around the image capturing lens 106A, and emits light to the subject.

The light emitter 114 is configured by including an LED or the like, and used for notification to the user in addition to supplemental illumination of the subject.

### [Operation of Image Capturing Device 1]

Next, the operation of the image capturing device 1 will be described.

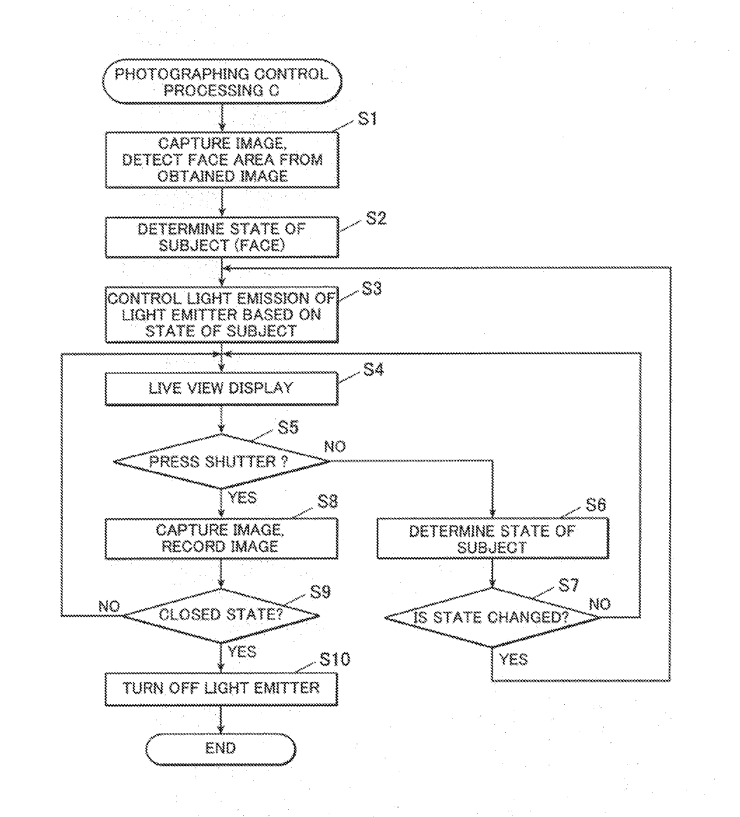

FIG. 3 is a flowchart showing photographing control processing executed by the controller 101 in the image capturing device 1.

The photographing control processing is, for example, executed by cooperation between the controller 101 and the program stored in the storage 102 in a case where the opening/closing detector 109 detects the open state.

First, the controller 101 causes the image capturer 106 to perform image capturing, and detects the face area by the face detector 110 from the obtained image (step S1).

Next, the controller 101 causes the face image analyzer 111 to determine the state of the face detected in step S1 as the state of subject (step S2).

For example, the controller 101 causes the face image analyzer 111 to analyze the image of the face area to determine the direction to which the face as the subject is directed.

Alternatively, on the basis of the size of the detected face area, how close the face as the subject is located with respect to the image capturing device 1 may be determined.

Next, the controller 101 causes the lighting controller 112 to perform light emission control of the light emitter 113 and the light emitter 114 on the basis of the state of the detected face (step S3).

In step S3, the controller 101 individually adjusts the light amounts of the respective LEDs 113A to 113H and the LED of the light emitter 114 so as to equally emit light to the face area on the basis of the state of the detected face, for example.

For example, the controller 101 controls the light amounts of the respective LEDs 113A to 113H on the basis of the direction of the detected face.

The light emission control of the LEDs 113A to 113H is performed such that the light amount of the light emitter 113 is strong when the subject is located away, and the light amount of the light emitter 113 is weak when the subject is located close.

The strong/weak of the light amount of each of the LEDs 113A to 113H may be controlled by the lighting controller 112 causing the LEDs 113A to 113H to selectively emit light, may be controlled by changing the amount of the electric current flowing in each LED, and may be controlled by both of the above methods.

The LED of the light emitter 114 may be controlled to emit light by a predetermined light amount and the light may be turned off.

Next, the controller 101 performs image capturing of the subject illuminated by the light emitter 113 by the image capturer 106 at predetermined time intervals, and performs live view display on the display 103 (step S4).

Thus, the user can check the illumination state of the subject before photography.

Next, the controller 101 determines whether the shutter key 105A is pressed (step S5).

If it is not determined that the shutter key 105A is pressed (step S5: NO), the controller 101 causes the image capturer 106 to obtain an image, causes the face detector 110 to detect the face area from the obtained image, and causes the face image analyzer 111 to determine the state of the face of the subject (step S6).

If it is not determined that the state of the face of the subject is changed (step S6: NO), the controller 101 returns to step S4.

If it is determined that the state of the face of the subject is changed (step S6: YES), the controller 101 returns to step S3.

On the other hand, in step S5, if it is determined that the shutter key 105A is pressed (step S5: YES), the controller 101 causes the image capturer 106 to perform image capturing and record the obtained image of the subject in the image memory 108 (step S8).

Thus, it is possible to record the well-finished image of the subject which was photographed by illumination satisfying the user.

Next, the controller 101 determines whether the closed state of the image capturing device 1 was detected by the opening/closing detector 109 (step S9).

If it is not determined that the closed state of the image capturing device 1 was detected (step S9: NO), the controller 101 returns to step S4.

If it is determined that the closed state of the image capturing device 1 was detected (step S9: YES), the controller 101 causes the lighting controller 112 to turn off the LEDs of the light emitter 113 and the light emitter 114 (step S10), and ends the photographing control processing.

In such a way, according to the embodiment, it is possible to provide illumination highly satisfying the user since the light emitting manner of the light emitter 113 is controlled according to the state of the subject.

Between the steps S3 and S4, the controller 101 may use the image capturer 106 to measure the light around the image capturing device, obtain the level of the environmental light (environmental light Lv) and adjust the light emitting amounts of the LEDs 113A to 113H and 114 according to the environmental light Lv.

More specifically, the environmental light level is set to approximately Lv0 to Lv7. Lv3 corresponds to the brightness of the indoor light.

On the other hand, Lv0 is set for the darkest environment. The light emitting amounts of the LEDs 113A to 113H are lowered in a bright environment, and the light emitting amounts of the LEDs 113A to 113H are raised in a dark environment.

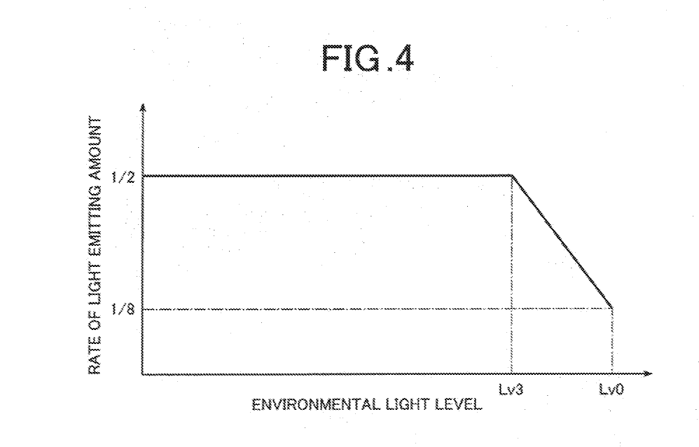

As illustrated in FIG. 4, when the environmental light level is Lv3 or greater, the ratio between the light emitting amounts of the LEDs 113A to 113H and the light emitting amount of the light emitter 114 is nearly 1:1.

At this time, in a case where the total of light emitting amounts is “1”, the total light emitting amounts of LEDs 113A to 113H and the light emitting amount of the light emitter 114 are set to have a same rate (1/2).

In accordance with the change from Lv2 to Lv0, that is, the darkening of the surroundings, the light emitting amount of the light emitter 114 is set to have a smaller rate. When the environmental light level finally becomes Lv0, the light emitting amounts of LEDs 113A to 113H are set to 7/8, whereas the light emitting amount of the light emitter 114 is set to 1/8.

By the above configuration, it is possible to provide illumination highly satisfying the user since the illumination light can be emitted with more natural light emitting amount to the subject according to the brightness of the environment.

Though the embodiment of the present invention has been described above, the embodiment is a preferred example of the image capturing device according to the present invention, and the present invention is not limited to this.

For example, though the state of the subject is determined on the basis of the detected state of the face in the captured image in the embodiment, the state of the subject may be determined by combining other detections and detection results such as the posture of the image capturing device when the user as the subject holds the image capturing device, and the image capturing position of the subject in the captured image.

Thus, it is possible to detect more detailed state of the subject.

Though the light emitting manner of the light emitter 113 is controlled by controlling the light amounts of the LEDs 113A to 113H of the light emitter 113 in the embodiment, the emission color may be controlled.

Though the above description describes an example of using a hard disk or a non-volatile memory of the semiconductor as a computer readable medium of the program according to the present invention, the present invention is not limited to this example.

A portable recording medium such as a CD-ROM can be applied as other computer readable medium.

A carrier wave is also applied as a medium providing the program data according to the present invention via the communication line.

As for the other detailed configurations and the detailed operations of the components forming the image capturing device, modifications can be appropriately made within the scope of the present invention.

Although several embodiments of the present invention have been described, the scope of the present invention is not limited to the above described embodiments and includes the scope of the present invention that is described in the claims and the equivalents thereof.

What is claimed is:

1. An image capturing device, comprising:
an image capturer;
a plurality of light emitters which is arranged around the image capturer and emits light for illuminating a subject; and
a controller, wherein
the controller detects a face area of the subject from an image captured by the image capturer, determines a state of the detected face area, and controls a light emitting manner of the light emitter based on a determination result.

2. The image capturing device according to claim 1, wherein the controller further determines a size of the detected face area in the captured image or a direction in which a face is directed, and controls the light emitting manner based on the determination result.

3. The image capturing device according to claim 1, wherein the controller individually adjusts light amounts of the plurality of light emitters such that light is equally emitted to the face area based on a detected state of the face area.

4. The image capturing device according to claim 1, further comprising a display, wherein the controller causes the image capturer to capture a face area which is brightened with light emission by the plurality of light emitters, and causes the display to display the captured face area.

5. The image capturing device according to claim 1, further comprising a recorder, wherein the controller causes the image capturer to capture a face area which is brightened with light emission by the plurality of light emitters, and causes the recorder to record the captured face area.

6. An image capturing method in an image capturing device that includes an image capturer and a plurality of light emitters which is arranged around the image capturer and emits light for illuminating a subject, the method comprising:
a detection step of detecting a face area of the subject from an image captured by the image capturer;
a determination step of determining a state of the face area detected in the detection step, and
a control step of controlling a light emitting manner of the light emitter based on a determination result by the determination step.

7. The image capturing method according to claim 6, wherein
in the determination step, a size of the detected face area in the captured image or a direction in which a face is directed is determined, and
in the control step, the light emitting manner is controlled based on the determination result.

8. The image capturing method according to claim 6, wherein the control step includes an adjustment step of individually adjusting light amounts of the plurality of light emitters such that light is equally emitted to the face area based on a detected state of the face area.

9. The image capturing method according to claim 6, further comprising:
an image capturing control step of causing the image capturer to capture a face area which is brightened with light emission by the plurality of light emitters; and
a display output step of causing the face area captured in the image capturing control step to be output to be displayed.

10. The image capturing method according to claim 6, further comprising:
an image capturing control step of causing the image capturer to capture a face area which is brightened with light emission by the plurality of light emitters; and
a recording step of causing a recorder to record the face area captured in the image capturing control step.

11. A non-transitory storage medium storing a program which is readable by a computer used in an image capturing device that includes an image capturer and a plurality of light emitters which is arranged around the image capturer and emits light for illuminating a subject, the program causing the computer to function as:
a detector which detects a face area of the subject from an image captured by the image capturer;
a determiner which determines a state of the face area detected by the detector, and
a controller which controls a light emitting manner of the light emitter based on a determination result by the determiner.
